(19) United States
(12) Patent Application Publication
(10) Pub. No.: US 2004/0083593 A1
(43) Pub. Date: May 6, 2004

(54) Fiberglass hole plug

(76) Inventors: Mike Jackson, Belding, MI (US); Ramesh Rajagopal, Chennai (IN)

Correspondence Address: Russell D. Orkin, WEBB ZIESENHEIM LOGSDON ORKIN & HANSON, P.C., 700 Koppers Building, 436 Seventh Avenue, Pittsburg, PA, 15219-1818, US

(21) Appl. No.: 10/285,340

(22) Filed: Oct. 30, 2002

(51) Int. Cl. B23P 19/00; B21D 39/00

(52) U.S. Cl. 29/456

(57) ABSTRACT

A fiberglass hole plug for sealing unused openings in electrical enclosures.

### BACKGROUND OF THE INVENTION

1. Field of the Invention

This invention relates to hole plugs and, more particularly, to a fiberglass hole plug for sealing holes in electrical enclosures.

2. Description of Prior Art

Electrical enclosures of various sizes and shapes are used in many different applications. These enclosures are usually prefabricated with a plurality of prepositioned circular openings or holes for allowing electrical cables or wires to be installed through these openings for connection to a variety of electrical components secured within the enclosure. Depending on the type, number, and configuration of electrical components that are to be secured in the enclosure, an estimated number of openings are cut in the enclosure wall. If this estimated number of openings is high, a certain number of the openings will remain unused and exposed. Typically, it is advantageous to add additional openings for unexpected equipment or for future expansion. Electrical codes require that these unused openings be covered.

One method of covering these unused and exposed openings is the use of vinyl adhesive-backed dots which are placed over the openings. However, these vinyl adhesive-backed dots may not withstand corrosive or harsh outdoor environments where these electrical enclosures may be located. Other types of hole plugs, such as soft rubber plugs, may break down in some corrosive atmospheres because of their susceptibility to ultraviolet degradation and brittleness from extreme temperature variations. Typically, hole plugs that are able to withstand corrosive and extreme temperature variations are typically made of stainless steel, zinc plated carbon steel or painted carbon steel. However, the cost associated with these types of materials for use in the manufacture of hole plugs is expensive. It is, therefore, an object of the present invention to overcome the above deficiencies by providing an inexpensive hole plug that can withstand corrosive atmospheres, extreme temperature variations, and ultraviolet degradation.

### SUMMARY OF THE INVENTION

The present invention is a hole plug for plugging a hole in a panel. The hole plug includes a first section and a second section. The first section includes a dome-shaped cover having a first side and a second side and a threaded member having a first end and a second end. The second end of the threaded member is attached to the second side of the cover and axially extends in a direction away from the cover. A planar surface for engaging a panel wall is defined on the second side of the cover. An annular groove is also defined on the second side of the cover. The cover and the threaded member can be integrally formed from a unitary piece of molded fiberglass.

The second section includes a fastener such as a nut threadably attached to the threaded member, whereby rotation of the fastener adjusts a longitudinal distance between the first end and the second end of the threaded member. The fastener includes an annular body having a first end and a second end and a flange having a first surface and a second surface. An internally threaded center passageway for receiving the threaded member is defined in the body. The first surface of the flange is attached to the second end of the body and a pair of opposing tabs are integrally attached to both the first surface of the flange and the body, wherein the tabs extend from the first end to the second end of the body and extend radially in a direction away from the center passageway. Because the fastener is not exposed to the environment outside of the enclosure, the fastener can be made of the same fiberglass material as the cover and the threaded member or any other durable material such as metal or rigid plastic.

The present invention provides a hole plug assembly for plugging a hole in a panel that includes a fiberglass hole plug as previously discussed and a gasket attached to the second side of the cover, wherein the gasket is adapted to provide a seal between the second side of the cover and a panel wall. The gasket such as an annular ring or washer can be made of rubber or foam. The annular ring can be adapted to fit into the groove of the cover. The assembly further includes a spacer having a central aperture adapted to be insertable into an opening of a panel wall, wherein said threaded member is adapted to be insertable through said aperture of said spacer. The spacer can be made of an elastomeric material, plastic or metal.

The present invention also provides a method of plugging a hole in a panel. The method includes providing a fiberglass hole plug as previously described and inserting the first end of the threaded member through an opening in a panel wall. Next, the fastener is fastened onto the first end of the threaded member and rotated until the second side of the cover covering the opening is securely fastened against the panel wall. The method further includes the step of inserting a spacer into the opening of the panel wall before inserting the threaded member through the opening, wherein the size of the opening in the panel wall is decreased. A gasket can also be inserted between the second side of the cover and the panel wall prior to inserting the first end of the threaded member through an opening in a panel wall.

A complete understanding of the invention will be obtained from the following description when taken in connection with the accompanying drawing Figures, wherein like reference characters identify like parts throughout.

### BRIEF DESCRIPTION OF THE DRAWINGS

FIG. 1 is a side elevational view of a fiberglass hole plug made in accordance with the present invention;

FIG. 2 is a perspective view of a first section member of the fiberglass hole plug of FIG. 1;

FIG. 3 is a front elevational view of the first section member of FIG. 2;

FIG. 4 is a section taken along lines IV-IV of FIG. 3;

FIG. 5 is a perspective view of a second section member of the fiberglass hole plug shown in FIG. 1;

FIG. 6 is a plan view of the second section member shown in FIG. 5;

FIG. 7 is a section taken along lines VII-VII of FIG. 6;

FIG. 8 is a fiberglass hole plug assembly made in accordance with the present invention;

FIG. 9 is a sectional view taken along lines IX-IX of FIG. 8;

FIG. 10 is a perspective view of a gasket shown in FIG. 9;

FIG. 11 is a perspective view of a spacer shown in FIG. 9; and

FIG. 12 is a sectional, side elevational view of a second embodiment of a hole plug assembly made in accordance with the present invention.

### DETAILED DESCRIPTION OF THE INVENTION

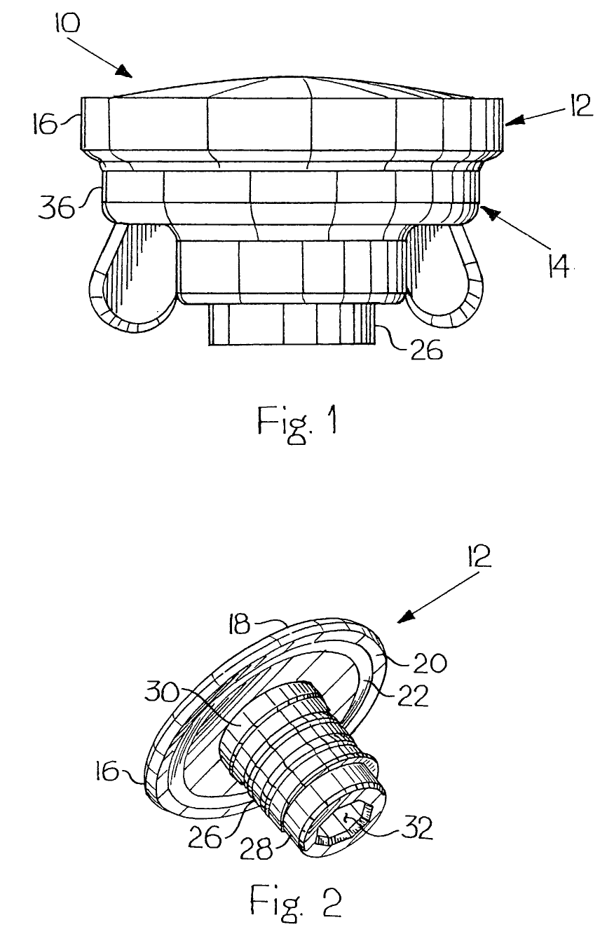

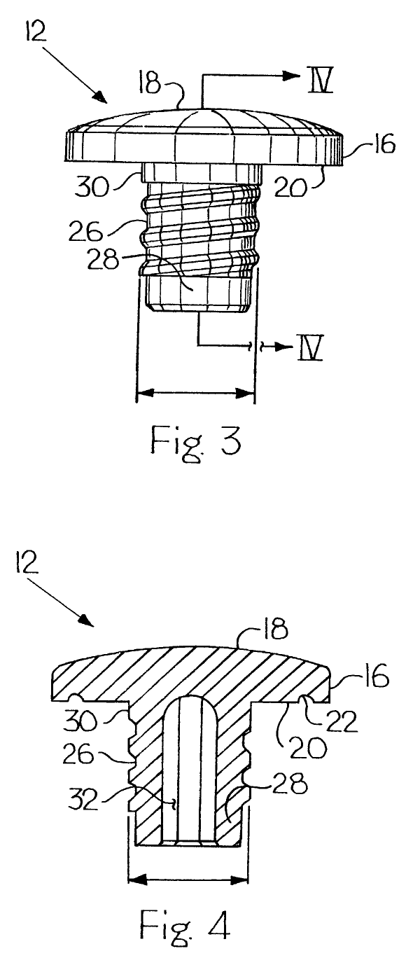

FIG. 1 shows a fiberglass hole plug 10 made in accordance with the present invention that includes a first section 12 and a second section 14. The first section 12 shown in FIGS. 2-4 includes a cover 16 having a first side 18 and a second side 20 and a threaded member 26 having a first end 28 and a second end 30. The second end 30 of the threaded member 26 is attached to the second side 20 of the cover 16 and axially extends in a direction away from the second side 20 of the cover 16. The first side 18 of the cover 16 can be dome-shaped. A planar surface having an annular groove 22 is defined on the second side 20 of the cover 16. A center cavity 32 defined in the threaded member 26 extends from the first end 28 to the second end 30 of the threaded member 26. The cover 16 and the threaded member 26 can be formed from a unitary piece of molded fiberglass. By “fiberglass” is meant a fiberglass reinforced thermoset molding compound such as a sheet molding compound (SMC) or a bulk molding compound (BMC). SMC and BMC are well known in the art of making reinforced molding compounds.

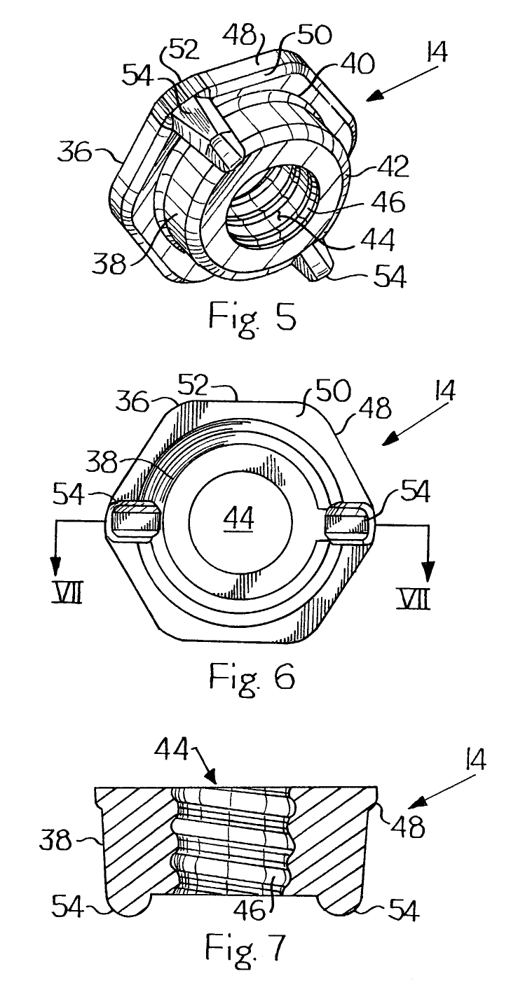

The second section 14 of the hole plug 10 shown in FIG. 1 includes a fastener 36 such as a nut. Referring to FIGS. 5-7, the fastener 36 includes an annular body 38 having a first end 40 and a second end 42. An internally threaded center passageway 44 is defined in the body 38 and includes internal grooves 46 for receiving the threaded member 26 of the first section 12. The fastener 36 also includes a flange 48 having a first surface 50 and second surface 52. The first surface 50 of the flange 48 is attached to the first end 40 of the body 38. The fastener also includes a pair of tabs 54 opposed to each other and integrally attached to the first surface 50 of the flange 48 and the body 38. Each tab 54 extends from the first end 40 to the second end 42 of the body and in a radial direction away from the center passageway 44. The fastener 36 can be threadably attached to the threaded member 26, whereby rotation of the fastener 36 adjusts a longitudinal distance between the first end 28 and the second end 30 of the threaded member 26. The fastener 36 can also be made of the same material as the cover 16 and the threaded member 26. Because the fastener 36 is typically on the inside of a panel and should not be exposed to the same external conditions as the cover 16, the fastener 36 can be made of any suitable material such as metal, plastic or rubber.

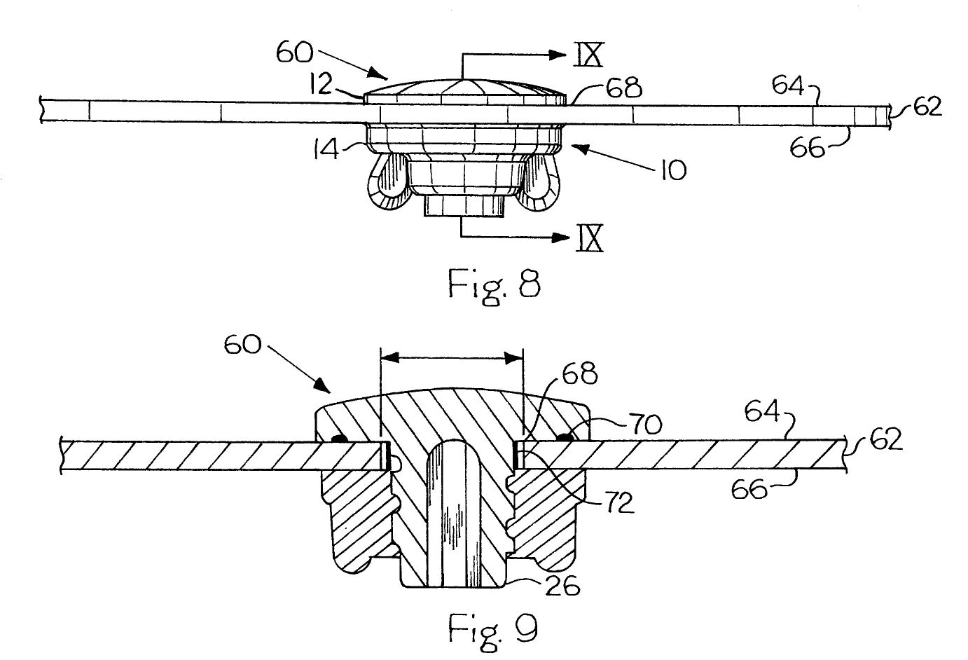

FIGS. 8 and 9 show a fiberglass hole plug assembly 60 for plugging an opening 68 defined in a panel wall 62 having a first surface 64 and a second surface 66. The hole plug assembly 60 includes hole plug 10 and an annular gasket 70 positioned between the second side 20 of the cover 16 and the first surface 64 of the panel wall 62 as shown in FIG. 9. Referring to FIGS. 9 and 10, the threaded member 26 extends through the opening 68 in the panel wall 62 and the gasket 70, such as an O-ring, is fitted into the groove 22 on the second side 20 of the cover 16. The gasket 70 can be made of an elastomeric material such as rubber or neoprene or a foam material such as ethylene propylene diene monomer (EPDM) or silicone. The assembly 60 can also include a spacer 72 (shown in FIG. 11) that includes a body 73 having an inner surface 74 and an outer surface 76 and defining a center aperture 78. The spacer 72 having a predetermined thickness is inserted into the opening 68 in order to reduce the diameter of the opening 68 in the panel wall 62, thereby allowing a certain size hole plug 10 to be used on a wide variety of different size openings. The spacer 72 is preferably of a width essentially equal to the thickness of the panel wall 62 and having a diameter slightly less than the diameter of the opening 68 in the panel wall 62. The fastener 36 threadably engages the threaded member 26 and is rotated a longitudinal distance towards the first end 28 of the threaded member 26 until the second surface 52 of the flange 48 is secured against the second surface 66 of the panel wall 62. When the fastener 36 is tightened, the second side 20 of the cover 16 engages the first surface 64 of the panel wall 62, thereby forming a seal with the gasket 70.

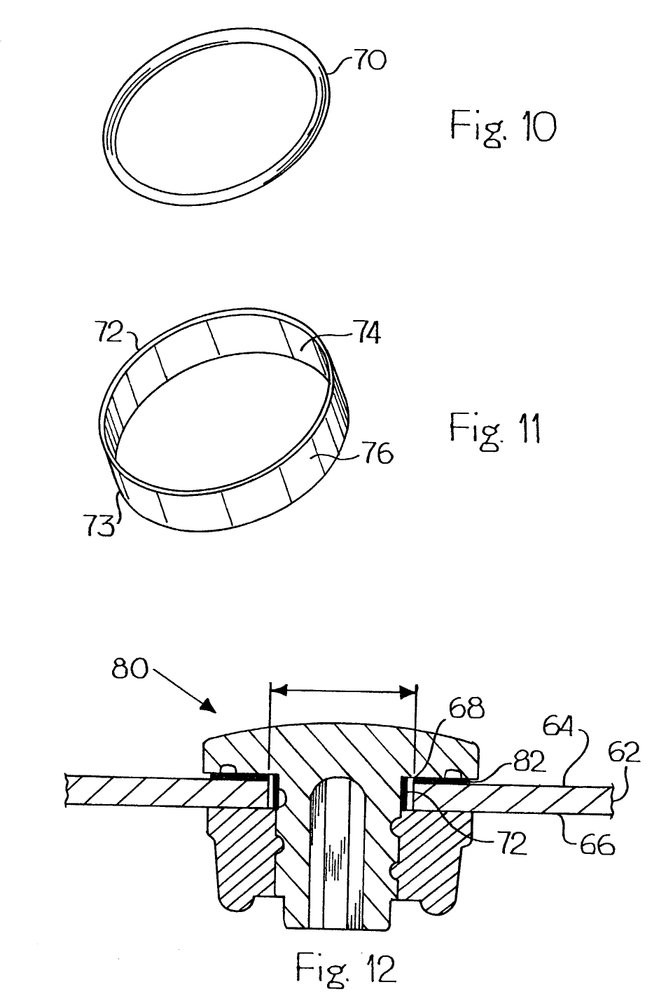

FIG. 12 shows a second embodiment 80 of the present invention that is similar to the hole plug assembly 60, except that the gasket 70 can be a washer 82. The washer 82 can be an annular-shaped ring having a planar surface and can also be made of an elastomeric material such as rubber or a foam material such as EPDM or silicone. The washer 82 covers the second side 20 of the cover 16, thus providing a seal between the cover 16 and the panel wall 62.

A method of plugging a hole in a panel includes the steps of providing a fiberglass hole plug 10 as previously discussed. Second, a gasket 70 is fitted into the annular groove 22 of the cover 16. Third, the first end 28 of the threaded member 26 is inserted through the opening 68 in the panel wall 62 and the fastener 36 is fastened onto the first end 28 of the threaded member 26. Fourth, the fastener 36 is rotated until the second surface 52 of the flange 48 comes into contact with the second surface 66 of the panel wall 62, thereby sealing the cover 16 over the opening 68. A spacer 72 can be inserted into the opening 68 prior to inserting the threaded member 26 through the opening 68 in the panel wall 62. The gasket 70 in the second step can be replaced by a washer 82 inserted between the second side 20 of the cover 16 and the panel wall 62.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A hole plug for plugging a hole in a panel, said hole plug comprising:
a cover having a first side and a second side;
an annular groove defined on said second side of said cover;
a threaded member having a first end and a second end, said second end of said threaded member attached to said second side of said cover and axially extending in a direction away from said cover; and
a fastener threadably attached to said threaded member, whereby rotation of said fastener adjusts a longitudinal distance between said first end and said second end of said threaded member.

2. The hole plug as claimed in claim 1, wherein said hole plug is comprised of fiberglass.

3. The hole plug as claimed in claim 1, wherein said first side of said cover is dome-shaped.

4. The hole plug as claimed in claim 1, wherein said second side of said cover defines a planar surface for engaging a panel wall.

5. The hole plug as claimed in claim 1, wherein said cover and said threaded member are integrally formed from a unitary piece of molded fiberglass.

6. The hole plug as claimed in claim 1, wherein said fastener is a nut.

7. The hole plug as claimed in claim 1, wherein said fastener comprises:
an annular body having a first end and a second end, said body defining an internally threaded center passageway for receiving said threaded member;
a flange having a first surface and a second surface, said first surface of said flange attached to said second end of said body; and
a pair of tabs opposed to each other and integrally attached to both said first surface of said flange and said body, said tabs extending from said first end to said second end of said body and extending radially in a direction away from said center passageway.

8. A hole plug as claimed in claim 7, wherein said fastener is made of an elastomeric material or metal material.

9. A hole plug assembly for plugging a hole in a panel, said assembly comprising:
a fiberglass hole plug comprising a cover having a first side and a second side, an annular groove defined on said second side of said cover, a threaded member having a first end and a second end, said second end of said threaded member attached to said second side of said cover and axially extending in a direction away from said cover, and a fastener threadably attached to said threaded member, whereby rotation of said fastener adjusts a longitudinal distance between said first end and said second end of said threaded member; and
a gasket attached to said second side of said cover adapted to provide a seal between said second side of said cover and a panel wall.

10. The assembly as claimed in claim 9, wherein said gasket is comprised of an elastomeric material.

11. The assembly as claimed in claim 9, wherein said gasket is comprised of foam.

12. The assembly as claimed in claim 9, wherein said gasket is an annular ring adapted to fit into said groove of said cover.

13. The assembly as claimed in claim 9, wherein said gasket is a washer.

14. The assembly as claimed in claim 9, further comprising a spacer having a central aperture adapted to be inserted into an opening of a panel wall, wherein said threaded member is adapted to be insertable through said aperture of said spacer.

15. The assembly as claimed in claim 14, wherein said spacer is comprised of an elastomeric material.

16. The assembly as claimed in claim 14, wherein said spacer is comprised of metal.

17. A method of plugging a hole in a panel comprising the steps of:
(a) providing a hole plug comprising a cover having a first side and a second side, an annular groove defined on said second side of said cover, a threaded member having a first end and a second end, said second end of said threaded member attached to said second side of said cover and axially extending in a direction away from said cover, and a fastener threadably attached to said threaded member, whereby rotation of said fastener adjusts a longitudinal distance between said first end and said second end of said threaded member, wherein said threaded member extends through said opening in said wall and said fastener is threadably secured to said threaded member, thereby sealing said second side of said cover to said wall;
(b) inserting said first end of said threaded member through an opening in a panel wall;
(c) fastening said fastener onto said first end of said threaded member; and
(d) rotating said fastener until said second side of said cover covering said opening is securely fastened against said panel wall.

18. The method as claimed in claim 17, wherein said hole plug is comprised of fiberglass.

19. The method as claimed in claim 17, further comprising the step of inserting a spacer after step (a) into said opening of said panel wall, thereby decreasing the size of said opening in said panel wall.

20. The method as claimed in claim 17, further comprising the step of inserting a gasket between said second side of said cover and said panel wall before inserting said first end of said threaded member through an opening in a panel wall.
